(19) United States
(12) Patent Application Publication
(10) Pub. No.: US 2015/0331590 A1
(43) Pub. Date: Nov. 19, 2015

(54) USER INTERFACE APPLICATION LAUNCHER AND METHOD THEREOF

(71) Applicant: HEWLETT-PACKARD DEVELOPMENT COMPANY, L.P., Houston, TX (US)

(72) Inventor: Nozomu YASUI, Taipei (TW)

(21) Appl. No.: 14/761,450

(22) PCT Filed: Jan. 25, 2013
(86) PCT No.: PCT/US2013/023107

§ 371 Date: Jul. 16, 2015

(51) Int. Cl. G06F 3/0484; G06F 3/0488; G06F 3/0481

(52) U.S. Cl. CPC G06F 3/04842; G06F 3/04817; G06F 3/04883

(57) ABSTRACT

Embodiments of the present invention disclose a user interface application launcher and method thereof. According to one embodiment, a user interface comprising an active area and inactive area is displayed on an associated display. Upon detecting a window open event within the inactive area of the user interface, an application launcher window and a plurality of application icons are displayed proximate to an input location of the detected open event on the user interface.

### BACKGROUND

The ability to provide efficient and intuitive interaction between computer systems and users thereof is essential for delivering an engaging and enjoyable user-experience. Graphical user-interfaces (GUI) are commonly used for facilitating interaction between an operating user and the computing system. Generally, a GUI includes an input means for allowing a user to manipulate objects shown on an associated display, and an output means for allowing the computer system to indicate the effects of the manipulation. Today, most computer systems employ icon-based user interfaces that utilize icons and menus for assisting a user in navigating and launching content and applications on the computing system.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a simplified block diagram of the system for providing a user interface application launcher according to an example of the present invention.

FIGS. 2A and 2B are sample screen shots of an open input event for activating the application launcher view of the user interface in accordance with an example of the present invention.

FIGS. 2C and 2D are sample screen shots of an close input event for closing the application launcher view of the user interface in accordance with an example of the present invention.

FIG. 3 is an illustration of the application launcher window and application icons according to an example of the present invention.

FIGS. 4A-4F are sample illustrations of various arrangements of the application icons within an application launcher window according to an example of the present invention.

FIG. 5 is a simplified flow chart of the processing steps for providing the user interface application launcher in accordance with an embodiment of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

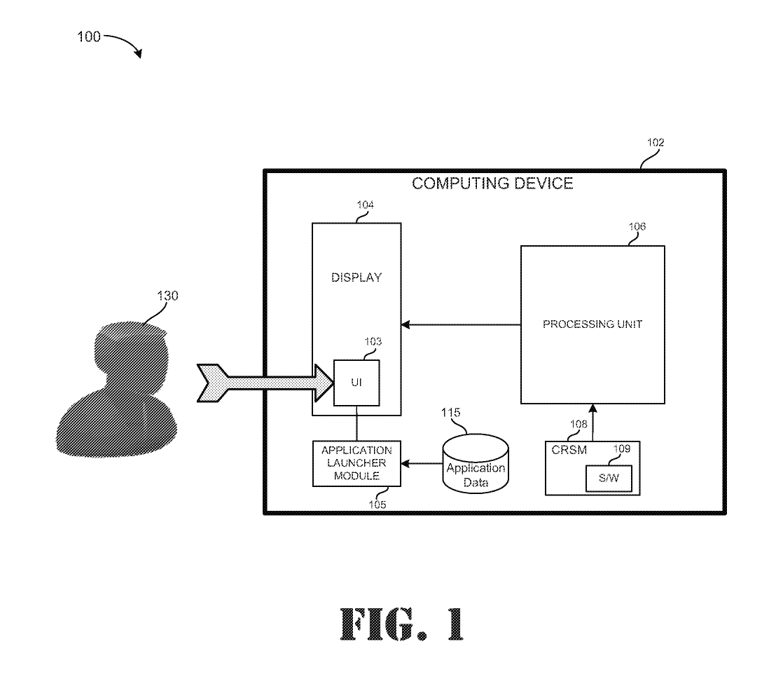

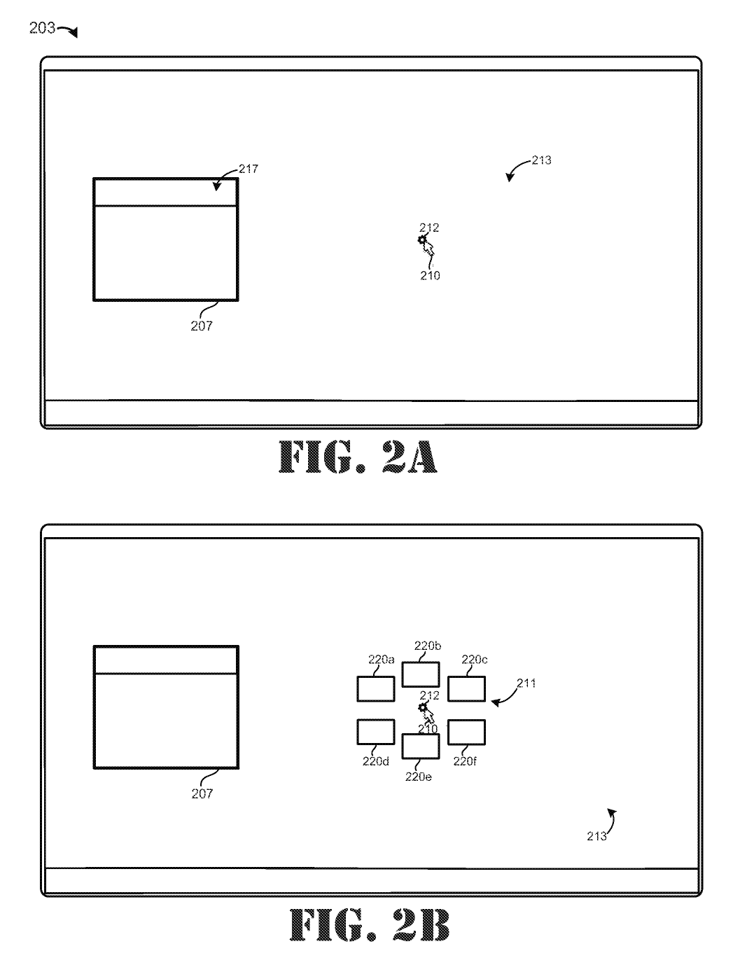

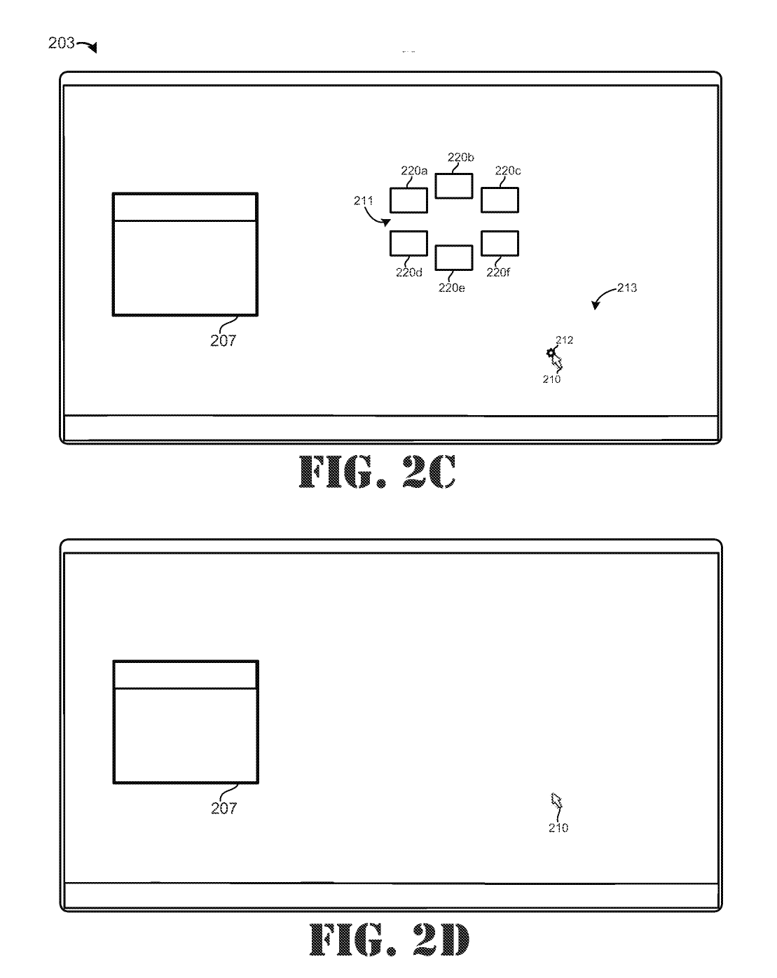

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Today, operating systems provide many ways to launch applications via an associated user interface. For example, modern operating system and application launchers thereof may utilize a full-screen based design. Such a configuration, however, requires a user to undesirably and continually switch between the menu screen and the desktop area for launching new applications. Other solutions include a “LaunchPad”, which works with touchpad gestures and display all applications in a full-screen list format for searching/browsing applications currently installed on the computer. In addition to certain compatibility issues, newer operating systems do not provide adequate support for legacy applications making it difficult to launch such applications (e.g., control panel settings, notepad, paint, etc.). Still further, most application launchers lack the ability to locate particular applications without keyboard input. Thus, there is a need in the art for a user interface that provides a simple and efficient way to launch any and all applications with or without keyboard operation.

Embodiments of the present invention disclose a user interface application launcher and method thereof. According to one example embodiment, the application launcher view is activated upon detecting an input event within an inactive area of the user interface. Thereafter, one or more application icons—each registered and associated with a software application—are displayed concentrically around the pointing element of the user interface. An application may be launched via user selection of one of the icons, or the application launcher window may be closed upon detection of a second input event within the inactive area of the user interface

Referring now in more detail to the drawings in which like numerals identify corresponding parts throughout the views, FIG. 1 is a simplified block diagram of the system for providing a user interface application launcher according to an example of the present invention. As shown in this example, the system 100 includes a user 130 operating a computing device 102. Computing device 102 includes a processing unit 106, display 104 and user interface 103, an application launcher module 105, an application data store 115, and a non-transitory computer-readable storage medium 108. In one embodiment, processing unit 106 represents a central processing unit (CPU), microcontroller, microprocessor, or logic configured to execute programming instructions associated with the user interface 105. Display unit 104 represents an electronic visual display configured to display objects and a graphical user interface 103 for enabling input interaction between the user 130 and the computing device 102. The application launcher module 105 communicates with the user interface 103 to activate an application launcher view or window upon detection of an application launch event (e.g., double mouse click in desktop area) from a user navigating the user interface 103. More particularly, and as will be further described and illustrated in the following example embodiments, the application launcher module 105 is configured to retrieved application data from the database storage 115, which includes registration information of software applications and associated application icons. Still further, storage medium 108 represents non-transitory, volatile storage (e.g. random access memory), non-volatile (e.g. hard disk drive, read-only memory, compact disc read only memory, flash storage, etc.), or combinations thereof. Moreover, storage medium 108 includes software 109 that is executable by processor 106 and, that when executed, causes the processing unit 106 to perform some or all of the functionality described herein. For example, instructions for providing the user interface and application launcher module 105 may be implemented as executable software within the storage medium 108.

FIGS. 2A and 2B are sample screen shots of an open input event for activating the application launcher view of the user interface in accordance with an example of the present invention. In accordance with one implementation, the user interface 203 includes an active application window 207 and a pointing element 210. As used herein, the pointing element 210 represents a mouse pointer and is utilized by the operating user to navigate the user interface 203 including the application window 207 (active area 217) and inactive area 213 (e.g., desktop area) as shown in FIG. 2A. The operating system and user interface includes functionality for tracking and detecting event and operations derived from user input (e.g., mouse click operation). As used herein, an active area 217 represents a portion of the user interface associated with a displayed object (e.g., application window, menu, icon, etc.), while an inactive area 213 represents a portion of the user interface not associated with an existing object (e.g., desktop). When an application launcher input event is detected within the inactive area 213, then the application launcher window 211 is activated and displayed on the user interface 203 as shown in FIG. 2B.

In accordance with the present example embodiments, the application launcher event may be mouse double-click operation, touchscreen tap, or gesture swipe (e.g., two-finger zoom operation) within the inactive area 213. However, the invention is not limited to these particular operations as the input event may include several operations as defined by the manufacturer or operator of the user interface. Moreover, as shown in FIG. 2B, the input event (e.g., double mouse click) causes the application launcher window 211 to display a plurality of application icons 220a-220f concentrically around the pointing element 210 (or input location 212). Furthermore, each application icon 220a-220f is associated with a registered software application, which may designated by the operating user as will be described in further detail below.

FIGS. 2C and 2D are sample screen shots of an input event for closing the application launcher view of the user interface in accordance with an example of the present invention. Here, the application launcher window 211 and application icons 22a-220f remain in the original position as the pointing element 210 is moved away from window 211. Upon detecting a close input event—such as a single click, touch input, or gesture—within the inactive area 213, the application launcher module closes the application launcher window 211 such that application icons 220a-220f are removed from view on the user interface as shown in FIG. 2D. Additionally, each application icon 220a-220f may be selected (e.g., via mouse click, tap) by an operating user so as to launch the associated application within the user interface. In one implementation, selection of an application icon by the user may also represent a close input event so as to both launch the associated application while also closing the application launch window 211.

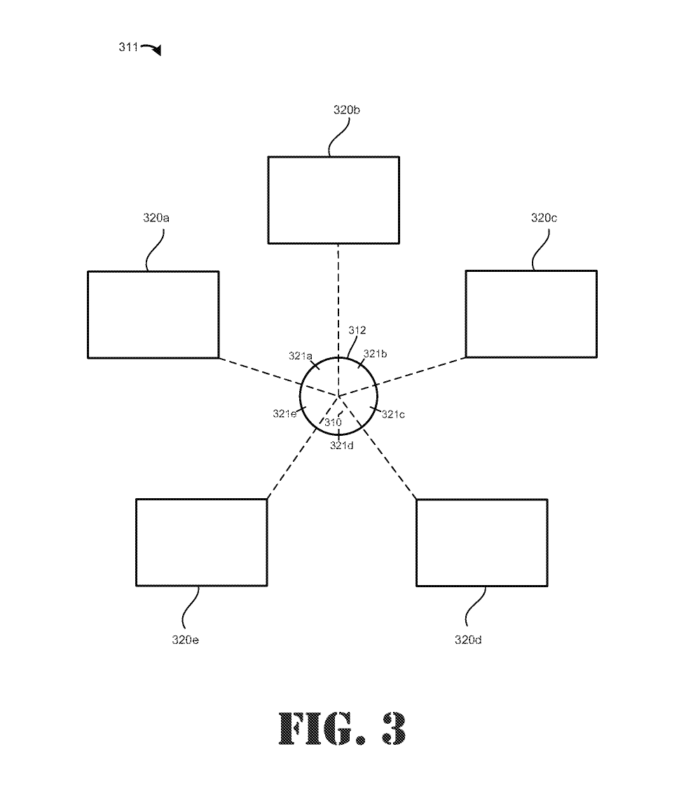

FIG. 3 is an illustration of the application launcher window and application icons according to an example of the present invention. Application launcher view 311 displays one or more application icons 320a-302e around the pointing element 310. As shown in the present example, the plurality of application icons 320a-320e are positioned concentrically around mouse cursor 310 such that each icon 320a-320e is located in a calculated degree from the mouse cursor. For example, and in accordance with one implementation, the application icons 320a-320e are formed around the graphical pointing element 310 at degree corresponding to [360*(1/x)], in which x equals the number of applications registered with the application launcher module. In the example of FIG. 3, the application launcher window 311 displays five application icons 320a-320f associated with five registered applications. Moreover, the application icons 320a-320f are positioned at an angle of 72 degrees (360*⅕) with respect to input location 312. In particular, the present example depicts the application icons 320a-320f positioned concentrically at equal angles (321a-321e) of 72 degrees each around the pointing element 312.

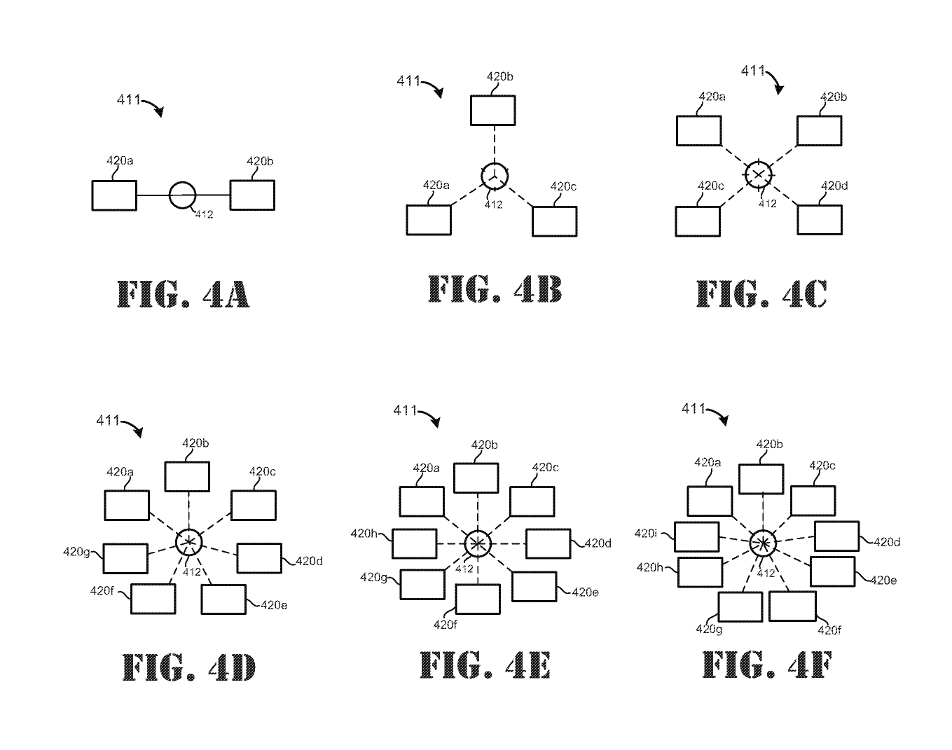

FIG. 4A-4F are sample illustrations of various arrangements of the application icons within the application launcher view according to an example of the present invention. As shown in FIG. 4A, the application window 411 includes applications icons 420a and 420b set on opposite ends of the activation point or input location 412. More particularly, the application icons are arranged at angles of 180° (360*½) with respect to the input location 412. FIG. 4B depicts an application window 411 including three applications icons 420a-420c. As shown here, each application icon 420a-420c is arranged at an angle of 120° (360*⅓) with respect to the activation point 412. Similarly, FIG. 4C depicts an application window 411 including four applications icons 420a-420d. Here, each application icon 420a-420d is arranged at an angle of 90° (360*¼) with respect to the input location 412. In yet another example implementation, FIG. 4D depicts an application window 411 including seven applications icons 420a-420c. As shown here, each application icon 420a-420g is arranged at an angle of 51° (360* 1/7) with respect to the input location 412. Finally, FIGS. 4E and 4F depict application window 411 including eight application icons 420a-420h and nine applications icons and 420a-420i respectively. More specifically, application icons 420a-420h are arranged at an angle of 45° (360*⅛), while application icons 420a-420i are arranged at an angle of 40° (360* 1/9) with respect to the input location 412.

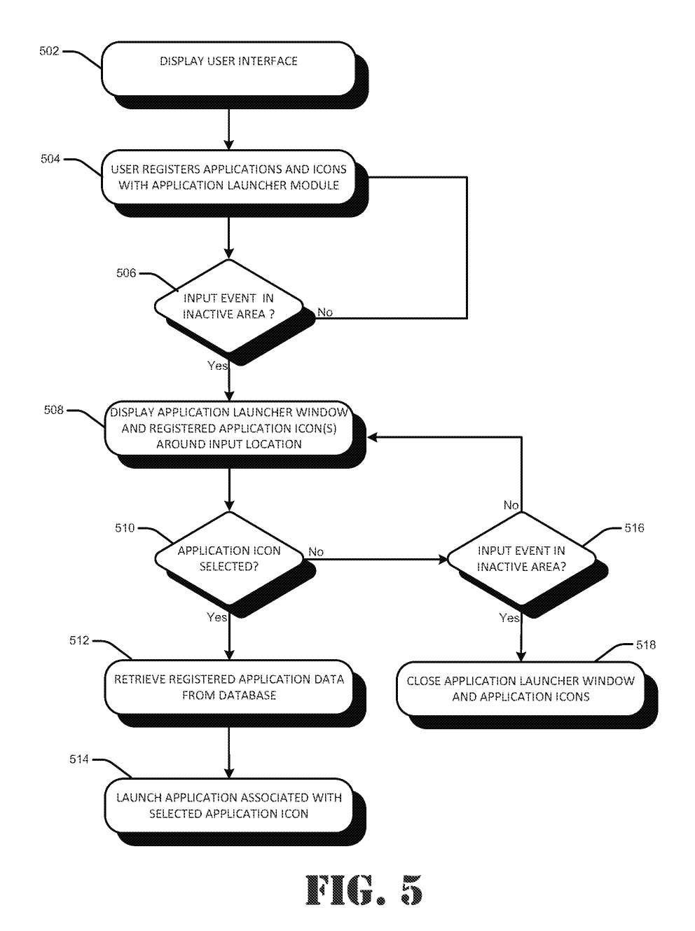

FIG. 5 is a simplified flow chart of the processing steps for providing the user interface application launcher in accordance with an embodiment of the present invention. In step 502, the user interface is presented on the display device for viewing and navigating by an operating user. Thereafter, in step 504, the user registers at least one application with the application launcher module. According to one example embodiment, the user utilizes menus of the user interface and operating system to select software applications for enabling quick launch access. Applications icons (preset or custom) associated with the selected software applications are then registered with application launcher module and stored in a database as application data. That is, application and mapping information are stored that links the application icon with a particular software application launch execution instruction. If a window open event (e.g., double mouse click, touch input, or gesture on desktop area) is detected in step 506, then the application launcher window including application icons associated with the registered applications are displayed concentrically around the input location in step 508 as described above. Furthermore, if the user selects one of the application icons displayed in the application launcher window in step 510, then the application launcher module retrieves the application data from the database in the step 512 so that the software application associated with the selected application icon may be launched in step 514. Conversely, if a window close event (e.g., single mouse click, touch input, or gesture on desktop area) is detected in step 516, then the application window and displayed application icons are closed and removed from view in step 518.

Embodiments of the present invention provide a user interface application launcher and method thereof. Moreover, many advantages are afforded by the user interface application launcher according to embodiments of the present invention. For instance, users are able to view and easily access their readily used applications while in the full-screen mode, thus enabling efficient multitasking when using multiple applications. Moreover, less-utilized and often hidden application icons (e.g., legacy applications such as notepad, calculator, paint, etc.) are easily discoverable in the user interface and example embodiments described herein.

Furthermore, while the invention has been described with respect to exemplary embodiments, one skilled in the art will recognize that numerous modifications are possible. For example, although exemplary embodiments depict a specific number of application icons within an application launcher window, the invention is not limited thereto. For example, the application window may include more or less than the number of application icons depicted and described in the present examples.

Moreover, not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement o order of elements or other features illustrated in the drawings or described herein need not be arranged in the particular way illustrated and described. Many other arrangements are possible according to some embodiments.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. A computer-implemented method for providing a user interface application launcher, the method comprising:
displaying a user interface comprising an active area and inactive area on an associated display;
detecting, via an application control module, a window open event based on input received from an operating user within the inactive area; and
displaying, based on the detected open event, an application launcher window including a plurality of application icons proximate to an input location of the detected open event on the user interface.

2. The computer-implemented method of claim 1, wherein the application launcher control module is configured to display the plurality of application icons concentrically around the input location.

3. The computer-implemented method of claim 1, further comprising:
receiving, at the application launcher control module, application registration information from a user for associating an application with an application icon;
storing the application registration information in a database.

4. The computer-implemented method of claim 3, wherein the step of displaying the plurality of application icons further comprises:
positioning each of the plurality of icons proximate to and concentrically around the input location at angles corresponding to: 360*(1/a), where a equals the number of applications registered with the application launcher control module.

5. The computer-implemented method of claim 3, wherein the launcher open event is a mouse double-click operation, touch input, or gesture operation within the inactive area of the user interface.

6. The computer-implemented method of claim 4, further comprising:
receiving input selection from a user relating to one of the application icons,
retrieving the application registration information from the database; and
launching the registered application associated with the selected application icon.

7. The computer-implemented method of claim 6, further comprising:
closing the application launcher window and plurality of application icons upon detecting a close window event within an inactive area of the user interface.

8. A system for proving an application launcher user interface comprising:
a display for displaying a user interface comprising an active and inactive area, wherein the user interface communicates input events from a user to the system;
an application launcher control module configured to display an application launcher window including a plurality of application icons proximate to an input location associated with a detected input event within the inactive area of the user interface.

9. The system of claim 8, wherein the application launcher control module is configured to display a plurality of application icons concentrically around the pointing element.

10. The system of claim 8, wherein each of the plurality of icons are associated with applications registered by the operating user.

11. The system of claim 10, wherein each of the plurality of icons are positioned proximate to each other around the input location at angle corresponding to: 360*(1/a), where a equals the number of registered applications.

12. The system of claim 8, wherein the launcher input event is a mouse double-click operation, touch input or gesture operation within the inactive area of the user interface.

13. The system of claim 8, wherein upon the user selecting an application icon from the application launcher, the registered application associated with the selected application icon is launched on the user interface.

14. The system of claim 13, wherein the application launcher window closes upon detecting a single mouse click in an inactive area of the user interface.

15. A non-transitory computer readable storage medium having stored executable instructions for providing a user interface application launcher on a device, that when executed by a processor, causes the processor to:
display a user interface comprising an active area and inactive area and a graphical pointing element on a display associated with the device;
receive application registration information from a user for associating an application with an application icon;
detect a window open event based on double mouse click received from an operating user within the inactive area; and
display a plurality of application icons on the user interface concentrically around the graphical pointing element based on the detected window open event,
wherein a registered application associated with a selected application icon is launched upon receiving user selection of an application icon on the application launcher window; and
wherein the application window and plurality of application icons are closed and removed from view upon detecting a single mouse click in an inactive area of the user interface.
